(19) United States
(12) Patent Application Publication
(10) Pub. No.: US 2017/0236212 A1
(43) Pub. Date: Aug. 17, 2017

(54) SYSTEM AND METHODS FOR IMPLEMENTING MULTI-BOOK ACCOUNTING IN A REAL-TIME FINANCIAL MANAGEMENT SYSTEM

(71) Applicant: NetSuite Inc., San Mateo, CA (US)

(72) Inventors: Brian Alexander Purville, San Francisco, CA (US); Michael (Xiaozheng) Ye, Foster City, CA (US); Stephen Clode, San Jose, CA (US)

(21) Appl. No.: 14/592,796

(22) Filed: Jan. 8, 2015

Related U.S. Application Data
(60) Provisional application No. 61/925,984, filed on Jan. 10, 2014.

(51) Int. Cl. G06Q 40/00

(52) U.S. Cl. CPC G06Q 40/12

(57) ABSTRACT

Systems and methods are shown for multi-book accounting involving first and second accounting books, processing real-time transactions received through a network by applying a first set of accounting rules corresponding to the first accounting book to the real-time transactions to produce the first accounting book, and applying a second set of accounting rules corresponding to the second accounting book to the real-time transaction to produce the second accounting book, where the second set of accounting rules differs from the first set of accounting rules. A user interface provides real-time access to the first and second accounting books. A user may define the second set of accounting rules and book specific attributes in the general ledger to produce the second accounting book.

This application claims the benefit of priority to U.S. Provisional Patent Application No. 61/925,984, filed Jan. 10, 2014, and entitled “System and Methods for Implementing Multi-Book Accounting in a Real-Time Financial Management System,” which is incorporated herein by reference in its entirety (including the Appendix) for all purposes.

### BACKGROUND

Users of financial accounting software often need to generate multiple copies of accounting results based on the same set of business transactions, in order to comply with country and/or industry specific accounting regulations. These copies of accounting data are typically termed “Accounting Books”, with each “book” indicating one integral set of accounting results. However, these accounting books may not represent real-time or current and up-to-date financial results for an enterprise if they are copied or derived from a previously generated (and hence fixed in time) set of data.

This lack of real-time data in an accounting book can be a problem for some users of the accounting books. For example, financial controllers or certain business users may need (or require) real-time insight into the financial performance of an enterprise and prefer to rely on real-time financial data and the ability to access and manipulate information contained in the accounting books (e.g., be able to apply analytical models or decision processes to the data and utilize real-time data in those processes).

Conventional approaches used by financial accounting systems to provide controllers with access to accounting books typically involve a two-step general ledger (GL) posting logic (referred to as sub-ledger accounting), in which the business transactions are disconnected from the run-time financial impact. However, this two-step logic introduces a time lag in the financial data; as a result, users don't always have real-time access to specific accounting results and the accuracy (and hence reliability) of the data being used may be questioned.

Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood not to limit the subject matter described herein or to limit the meaning or scope of the claims. Embodiments of the invention covered by this patent are defined by the claims and not by this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, to any or all drawings, and to each claim.

Embodiments of the invention are directed to systems, apparatuses, and methods for enabling an automated business data processing platform or system to generate multiple copies of real-time financial results based on pre-defined business and/or accounting rules. In one embodiment, the inventive system and methods generate multiple copies of real-time “book specific” accounting results, thereby achieving the end result of a conventional sub-ledger accounting system but with the benefit of enabling multiple copies of accounting results containing real-time financial data analytics.

An embodiment of an automatic real-time multi-book accounting system includes at least one storage device with a first accounting book and a second accounting book stored therein and at least one server device coupled to the storage device and configured to receive real-time transactions through a network. The server device processes each real-time transaction by applying a first set of accounting rules corresponding to the first accounting book to the real-time transaction and storing the result in the first accounting book and also applying a second set of accounting rules corresponding to the second accounting book to the real-time transaction and storing the result in the second accounting book, where the second set of accounting rules differs from the first set of accounting rules. A user interface provides real-time access to at least one of the first and second accounting books. In one refinement of the system, the second set of accounting rules includes a definition of one or more book specific attributes and the server device is further configured to apply the second set of accounting rules to the real-time transaction if the real-time transaction relates to one of the book specific attributes. In a further refinement, the user interface permits a user to define the book specific attributes and the second set of accounting rules

Another embodiment of an automatic real-time multi-book accounting system includes one or more storage devices with a general ledger, a first accounting book and a second accounting book stored therein. One or more server devices are coupled to the storage devices and are configured to receive real-time transactions through a network. The one or more server devices process each real-time transaction by storing the received real-time transaction in the general ledger, applying a first set of accounting rules corresponding to the first accounting book to the general ledger to produce the first accounting book, and applying a second set of accounting rules corresponding to the second accounting book to the general ledger to produce the second accounting book, where the second set of accounting rules differs from the first set of accounting rules. A first user interface provides real-time access to the first accounting book and a second user interface for real-time access to the second accounting book.

A refinement of the system produces multiple copies of accounting result across both primary book and secondary books simultaneously, by applying book generic accounting rules to book generic transactions and attributes, while applying book specific accounting rules to book specific transactions and attributes. In a further refinement, the system includes a user interface that allows the book specific attributes and the book specific accounting rules to be user defined.

In another refinement, the user interface for real-time access to the second accounting book is further configured to join the book generic attributes of the first accounting book and the book specific attributes of the second accounting book for presentation to the user. In still another refinement of the system, the server device is further configured to execute a pre-defined inquiry on the general ledger, apply the first set of rules to the book generic attributes in the inquiry results in order to produce results for the first book, and, if the inquiry is run for the second book, apply the second set of rules to the book specific attributes in the inquiry results in order to produce results for the second book.

In a different refinement of the system, the server device is further configured to execute a pre-defined inquiry on the general ledger. If the inquiry is run for the first book, the server device applies the first set of rules to the inquiry results in order to produce results for the first book. If the inquiry is run for the second book, the server device applies the second set of rules to the inquiry in order to produce results for the second book.

In yet another refinement of the system, the server device is further configured to execute a pre-defined inquiry on the general ledger, apply the first set of rules to the inquiry results in order to produce results for the first book, and, if the inquiry is run for the second book, apply the second set of rules to the results for the first book in order to produce results for the second book.

Other objects and advantages of the present invention will be apparent to one of ordinary skill in the art upon review of the detailed description of the present invention and the included figures.

### BRIEF DESCRIPTION OF THE DRAWINGS

Embodiments of the invention in accordance with the present disclosure will be described with reference to the drawings, in which:

FIG. 1 is a diagram illustrating elements or components of an example operating environment in which an embodiment of the invention may be implemented;

FIG. 2 is a diagram illustrating additional details of the elements or components of the multi-tenant distributed computing service platform of FIG. 1, in which an embodiment of the invention may be implemented;

FIG. 3 is a diagram illustrating a data schema that may be utilized in implementing an embodiment of the invention;

FIG. 4 is a diagram illustrating data flow and controller access for one embodiment of the invention;

FIG. 5 is a diagram illustrating data flow and controller access for another embodiment of the invention;

FIG. 6 is a table of use cases that may be suitable for application of the invention;

FIG. 7 is a flow chart or flow diagram illustrating a process, method, operation, or function for generating a report based on the inventive multi-book accounting method;

FIG. 8 is a functional block diagram illustrating an architecture that may be utilized in implementing an embodiment of the invention;

FIG. 9 is a flow chart or flow diagram illustrating a process, method, operation, or function for providing primary and secondary books based on the inventive multi-book accounting method;

FIG. 10 is a flow chart or flow diagram illustrating a process, method, operation, or function for generating a report based on the inventive multi-book accounting method; and

FIG. 11 is a diagram illustrating elements or components that may be present in a computer device or system configured to implement a method, process, function, or operation in accordance with an embodiment of the invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, or as one or more devices. Embodiments of the invention may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that are programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

Financial accounting software often is required to generate multiple copies of accounting results with the same set of business transactions in order to comply with country and industry specific accounting regulations. These copies of accounting data are technically named “Accounting Books”, with each book indicating one integral set of accounting result. Meanwhile, financial controllers and business users often want a real-time insight to their financial performance with instant data analytical access to these accounting books.

Current financial accounting systems handle this problem by using a two-step general ledger posting logic (also known as sub-ledger accounting), where the business transactions are disconnected from run-time financial impact. However, this two-step logic introduces a time lag to financial data, so users don't always have real-time access to book specific accounting results.

Embodiments of the present invention are directed to systems, apparatuses, and methods for enabling Multi-Book Accounting functionality, where such functionality provides the ability to maintain multiple sets of accounting records based on a single set of real-time financial transactions. Among other benefits, this allows a business to support different managerial and regulatory compliance needs.

Some embodiments of the present invention may provide multiple financial reports having different accounting rules in order to comply with country and industry specific regulatory requirements. For example, a company that maintains its primary accounting records according to United States Generally Accepted Accounting Principles (U.S. GAAP) can add accounting books to generate different versions of financial reports and statements that are mandated by local governments and/or industry regulations. For example, if you operate a US HQ multi-national business with a local office in UK, the UK operational results can be included in your global consolidated financial statements based on US GAAP, while you file local UK tax return reports and forms by translating the same set of transactions through UK GAAP.

Further, some embodiments of the invention include user interfaces that provide multiple financial reports having different accounting rules in real-time. Financial controllers and business users often want a real time insight to their financial performance with instant data analytical access to these accounting books. Such a real-time translation from business transactions to book specific accounting results greatly improves the timeliness of these key financial results. Real time transaction-level reports can be generated for individual accounting books to satisfy accounting and managerial reporting requirements and provide detailed transaction level audit trail for book specific financial statements. Saved searches and Key Performance Indicators (KPIs) displayed for each accounting book is also supported in some embodiments.

In some embodiments, dynamically generated book specific accounting results may be provided through reports, saved searches and Key Performance Indicators (KPIs) that may be displayed for each accounting book. A user interface enables a reporting engine to intelligently set the reporting data context based on the book selected on a user interface (UI). Because of this mechanism, existing reports and saved searches may continue to work in their pre-existing primary book context without additional configuration, and may be enhanced to generate similar results in a secondary book context. These embodiments also provide backward compatibility to existing users and their data analytical solution package with an easy path of upgrade.

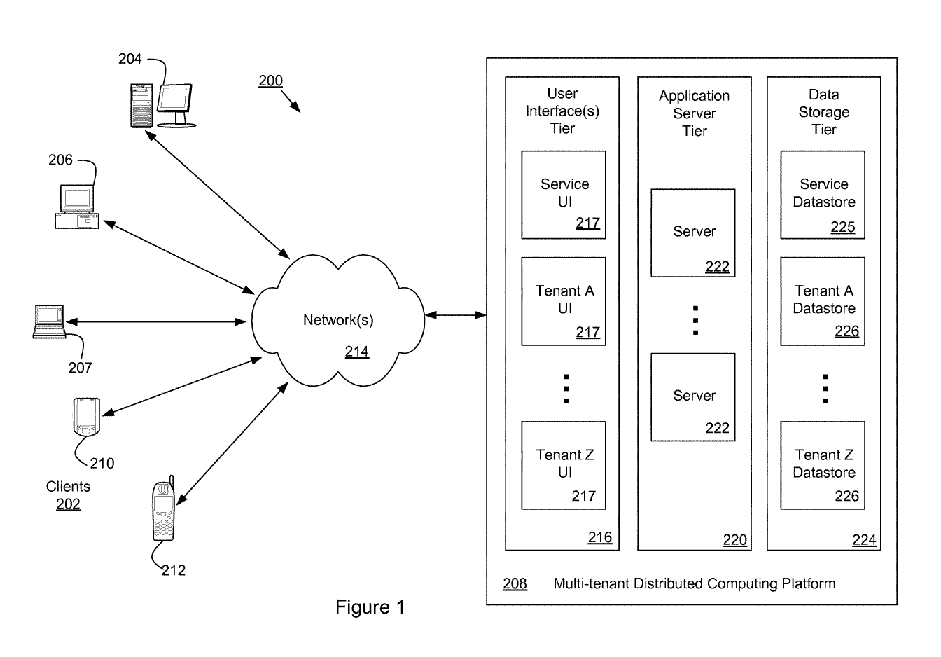

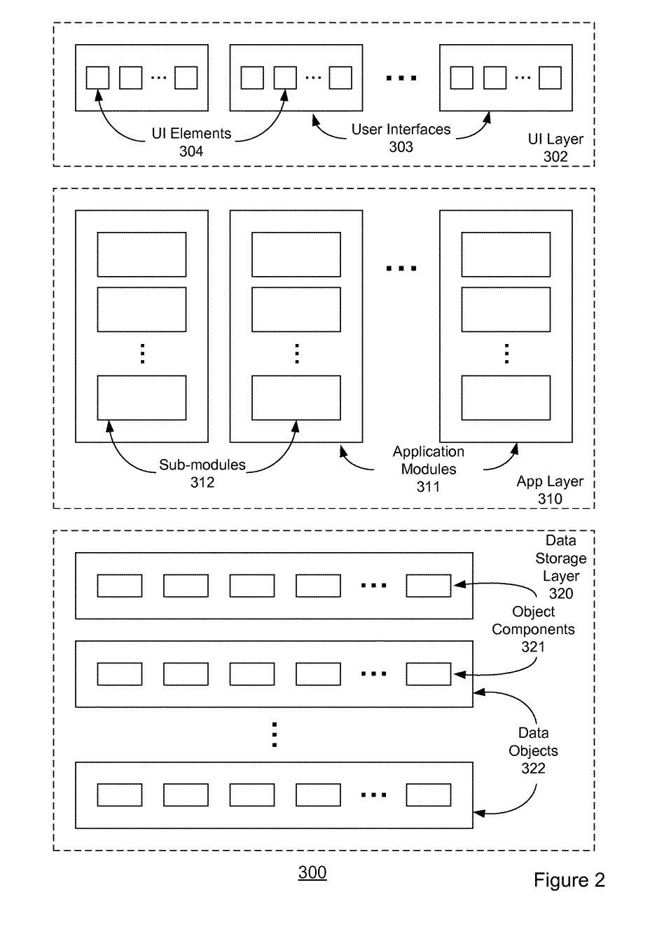

In some embodiments, the invention may be implemented in the context of a multi-tenant, “cloud” based environment (such as a multi-tenant business data processing platform), typically used to develop and provide web services for end users. This exemplary implementation environment will be described with reference to FIGS. 1 and 2. Note that embodiments of the invention may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, and web-based customer support, as well as reporting and analysis capabilities relating to these functions. With differing levels of overlap with ERP/CRM initiatives and with each other, efforts have also been directed toward development of increasingly integrated partner and vendor management systems, web store/eCommerce systems, product lifecycle management (PLM) systems, and supply chain management (SCM) systems.

FIG. 1 is a diagram illustrating elements or components of an example operating environment 200 in which an embodiment of the invention may be implemented. As shown, a variety of clients 202 incorporating and/or incorporated into a variety of computing devices may communicate with a distributed computing service/platform 208 through one or more networks 214. For example, a client may incorporate and/or be incorporated into a client application (e.g., software) implemented at least in part by one or more of the computing devices. Examples of suitable computing devices include personal computers, server computers 204, desktop computers 206, laptop computers 207, notebook computers, tablet computers or personal digital assistants (PDAs) 210, smart phones 212, cell phones, and consumer electronic devices incorporating one or more computing device components, such as one or more electronic processors, microprocessors, central processing units (CPU), or controllers. Examples of suitable networks 214 include networks utilizing wired and/or wireless communication technologies and networks operating in accordance with any suitable networking and/or communication protocol (e.g., the Internet).

The distributed computing service/platform (which may also be referred to as a multi-tenant business data processing platform) 208 may include multiple processing tiers, including a user interface tier 216, an application server tier 220, and a data storage tier 224. The user interface tier 216 may maintain multiple user interfaces 217, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 224 may include one or more data stores, which may include a Service Data store 225 and one or more Tenant Data stores 226.

Each tenant data store 226 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 208 may be multi-tenant and service platform 208 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions. Another business information system that may be provided as part of an integrated service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system may include: sales force automation (SFA), marketing automation, contact list management, call center support, and web-based customer support, as well as reporting and analysis capabilities relating to these functions. In addition to ERP and CRM functions, a business information system/platform (such as element 208 of FIG. 2) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, etc. A web server is a most often a combination of hardware and the software that helps deliver content (typically by hosting a website) to client web browsers that access the web server via the Internet.

Rather than build and maintain such an integrated business system themselves, a business may utilize systems provided by a third party. Such a third party (i.e., a platform operator, manager, or administrator) may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users, including customers and employees. Some of those multiple users may have distinct roles or responsibilities within the business or entity. As a result, such users may have a need or preference to utilize certain components of a user interface or functional aspects of the computing/data processing platform when performing their functions (such as by generating accounting books that enable them to track the real-time financial characteristics of specific transactions or business operations).

In some cases, a tenant may desire to modify or supplement the functionality of an existing platform application by introducing an extension to that application, where the extension is to be made available to the tenant's employees and/or customers. In some cases such an extension may be applied to the processing of one or more types of the tenant's business related data that is resident on the platform. The extension may be developed by the tenant or by a 3^{rd} party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as in the case of an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or cause their business data to be processed in a specific way in accordance with a defined workflow that is tailored to their business needs, etc. (such as by implementing a multi-book accounting system or functionality).

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application (such as multi-book accounting functionality). One or more tenants/users of the platform may wish to add the extension to the underlying application in order to be able to utilize the enhancements to the application that are made possible by the extension.

FIG. 2 is a diagram illustrating additional details of the elements or components of the multi-tenant distributed computing service platform of FIG. 1, in which an embodiment of the invention may be implemented. The software architecture depicted in FIG. 2 represents an example of a software system to which an embodiment of the invention may be applied, i.e., in which it may be implemented. In general, an embodiment of the invention may be implemented by a suitable set of software instructions that are designed to be executed by a suitably programmed processing element (such as a CPU, microprocessor, processor, controller, computing device, server, processing platform, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 2 is a diagram illustrating additional details of the elements or components 300 of the multi-tenant distributed computing service platform of FIG. 1, in which an embodiment of the invention may be implemented. The example architecture includes a user interface layer or tier 302 having one or more user interfaces 303. Examples of such user interfaces include graphical user interfaces and application programming interfaces (APIs). Each user interface may include one or more interface elements 304. For example, users may interact with interface elements in order to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 310 may include one or more application modules 311, each having one or more sub-modules 312. Each application module 311 or sub-module 312 may correspond to a particular function, method, process, or operation that is implemented by the module or sub-module. Such function, method, process, or operation may include those used to implement one or more aspects of the inventive system and methods, such as for:
Permitting a user to generate one or more accounting books (e.g., which may include generating a user interface to enable user interaction with one or more aspects of the invention);
Permitting a user to define one or more business rules or other forms of logic that describe and determine the content of an accounting book; and
Linking the generated accounting books to real-time financial data that is maintained and processed by a business data processing system/platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 222 of FIG. 1) may include each application module. Alternatively, different application servers may include different sets of application modules. Such sets may be disjoint or overlapping.

The data storage layer 320 may include one or more data objects 322 each having one or more data object components 321, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 1-2 are not intended to be limiting examples. Alternatively, or in addition, computing environments in which an embodiment of the invention may be implemented include any suitable system that permits users to provide data to, and access, process, and utilize data stored in a data storage element (e.g., a database) that can be accessed directly by a user or remotely over a network. Further example environments in which an embodiment of the invention may be implemented include devices, software applications, systems, processing platforms, apparatuses, or other elements or components that are used to acquire and process financial data and provide the results of that processing to users. Although further examples below may reference the example computing environment depicted in FIGS. 1-2, it will be apparent to one of skill in the art that the examples may be adapted for alternate computing devices, systems, apparatuses, processes, and environments.

Embodiments of the present multi-book accounting system utilize a split transaction line approach that generates multiple copies of real-time book specific accounting results, thus achieving the same end result of sub-ledger accounting system while enabling multiple copies of accounting results with real-time financial data analytics. The split transaction line approach divides ERP transaction data into book generic versus book specific attributes. The book generic attributes are kept intact in a transaction line detail table, while book specific attributes are relocated into an extended transaction line book detail table. Run-time transaction processing logic will automatically post transactions to both tables, with the transaction line book detail table containing book specific accounting results. Whether an attribute will stay in the primary transaction line detail table or be relocated to the transaction line book detail table, may be based on one or more of system defined rules, default behavior rules, or user defined accounting rules, and in that sense may be either book generic (i.e., applicable across all books) or book specific (i.e., applicable to a subset of the possible books).

For example, certain accounting attributes, such as a template defined on an item and then on its sales transactions, may be either book generic or book specific, depending on whether a user enables a particular sub-feature (typically by use of a configuration parameter, such as “Revenue and Expense Management in Multi-book Accounting”). If this parameter is ON, the result is book specific; otherwise this function is book generic. Note, however, that in the overall design of the system a parameter may always be placed in the transaction line (tranline) book detail table no matter whether it is book generic or specific (e.g., if it is book generic the system may maintain multiple copies in different books, but with the same value).

In one embodiment, a system may be configured ahead of time to specify attributes that will be stored in the book detail table (in which case they are always stored there regardless of the user defined accounting rules). In such a case, even if the user is using the same base currency in all books, the system will store the transaction base currency amount in the book detail table. Also, note that in some embodiments, data is not “relocated” as the system may keep a copy of the primary book value for the book specific attribute in the primary transaction line detail table. For example, the system may store the base currency amount for each book in the line book detail table and also store the primary book base currency amount in the line detail table. These design and implementation approaches provide flexibility to general ledger posting logic while providing a mechanism for reducing the potential negative impact on system performance. Meanwhile, data analytical tools (such as reports or saved searches) and cloud APIs are provided to enable access to the transaction line book detail table data without disruption to user experience or interfaces for the transaction line detail table.

With respect to several of the following diagrams, a primary book is an accounting record before multi-book accounting is enabled. Once multi-book accounting is enabled, the primary book is automatically configured and activated for access through a user interface as a separate entity from other accounting books. The primary book is the daily operational book where business transactions are recorded and viewed. Secondary or parallel books may have one or more differences from the primary book and are separately accessible through a user interface. For example, a secondary book may have different subsidiary base currency, post a particular transaction to different accounts than the primary book, and apply different accounting rules.

Book generic records, such as entity, general ledger or CRM records, are created and shared across all related accounting books. Generally, book generic attributes on a book generic transaction display the same result in reports and searches for all accounting books. Many book generic records, such as items, sales orders, sales invoices or vendor bills, may also include book specific attributes. For example, an item record may be visible in all books, but book specific information for revenue recognition and expense amortization is derived from the item record. Book specific records or accounting attributes yield different results depending upon the accounting book selected by the user. Book specific records are typically created for one book only and may include book specific journal entries (JEs), intercompany journal entries (ICJE), revenue commitment and reclassification JEs, revenue and expense allocation, revenue recognition and expense amortization schedules, or fixed asset depreciation.

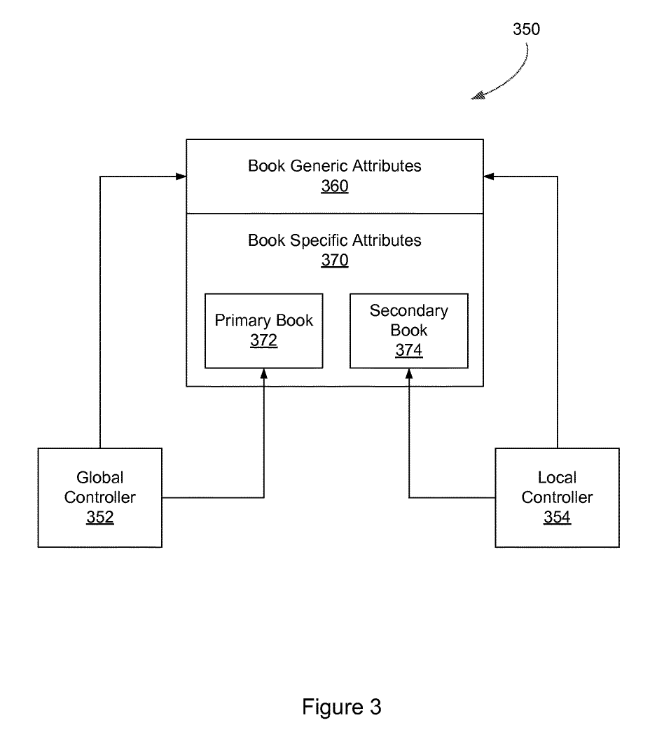

FIG. 3 is a diagram illustrating a data schema that may be utilized in implementing an embodiment of the invention. As shown in the figure and described herein, the invention permits definition of an accounting book that is decoupled from the General Ledger (GL), in that it is not derived directly from a fixed version of the GL, and which may be defined by one or more separate, book specific accounting, business, or operational rules or conditions. In conjunction with the operation of a multi-tenant business data processing platform as described with reference to FIGS. 1 and 2, this permits an accounting book to be based on real-time financial data as filtered or modified by a relevant set of rules or conditions.

The data schema of FIG. 3 illustrates an example of a relationship between data for a primary book and a secondary book for use by global and local controllers, where a system automatically posts to multiple accounting books according to pre-defined accounting rules. Both a global controller interface 352 and a local controller interface 354 may display some of the same book generic attributes 360. However, the global controller interface 352 displays the book specific attributes 370 for primary book 372, while the local controller interface 354 displays the book specific attributes for secondary book 374. The invention may allow users to define standard and custom accounting rules, which will be applied to real time business transactions and post to multiple accounting book General Ledgers (GLs) simultaneously. For example, a user can create different revenue recognition and expense amortization rules on a per-book basis. If you booked a sales transaction, in your primary book you can choose to recognize its revenue over a given time period, while immediately recognizing the full amount in a secondary book. By doing so, the invention alleviates the tedious manual adjustment and review workload to average accounting users, which is required in a conventional sub-ledger accounting system.

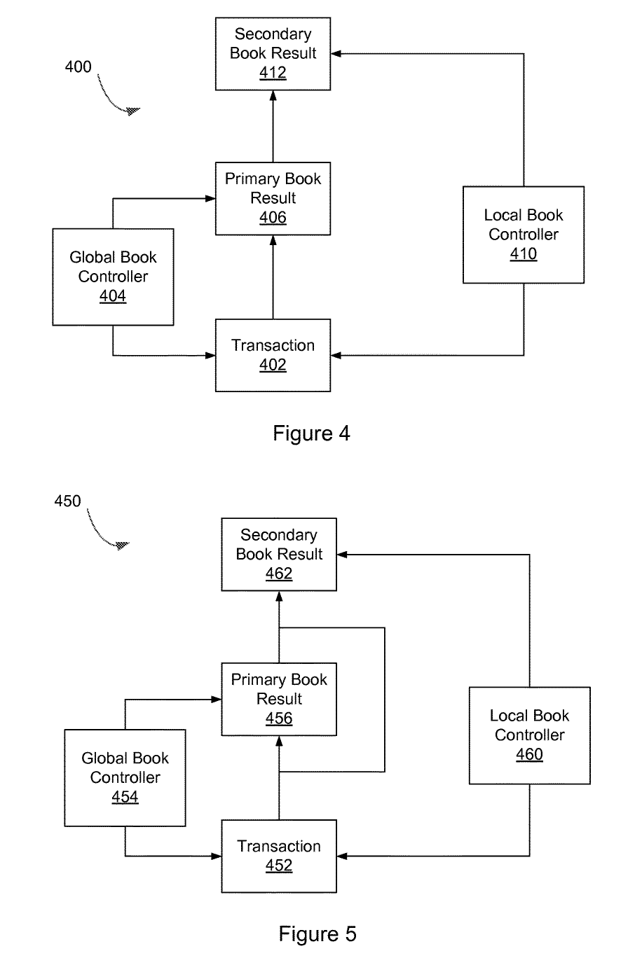

FIG. 4 is a diagram illustrating a data schema 400 for one embodiment of the invention that provides for adjustment based secondary book results. In this approach, a user can adjust the default accounting result by posting book specific journal entries to specific books. In data schema 400, transaction 402 is adjusted by global book controller 404 for entry in primary book result 406. However, local book controller 410 may make a book specific adjustment to transaction 402 that is different from the adjustment made by global book controller 404 and the result is stored as secondary book result 412. These adjustments may be done manually or performed by scripts on a cloud platform.

FIG. 5 is a diagram illustrating a data schema 450 for another embodiment of the invention that provides for rule driven accounting book results. In the rule driven approach, business transactions are processed with user defined accounting rules to automatically generate book specific accounting results. In data schema 450, transaction 452 is processed using rules defined by global book controller 404 to automatically generate a journal entry in primary book result 406. However, local book controller 460 may make define book specific rules for processing to transaction 452 that are different from the rules defined by global book controller 454 to automatically generate secondary book result 462. In this manner, shared business transactions may be automatically processed, e.g. using scripts on a cloud platform, to produce book specific accounting results.

### Examples of rule-driven automatic posting to book specific GLs may include

Same sales transaction, with book specific revenue recognition schedules;
Same sales transaction, with book specific revenue triggering events (e.g. billing vs. fulfillment);
Same multi-element sales transaction, with book specific revenue allocation rules (e.g. SOP-97-02 vs. EITF-08-01);
Same purchasing transaction, with book specific expense amortization schedules;
Same fixed asset object, with book specific depreciation methods and schedules;
Same business transactions, with book specific functional/reporting currency to revalue foreign currency exchange rate gain/loss; and
Same revenue/expense allocation schedule, with book specific dynamic allocation weights.

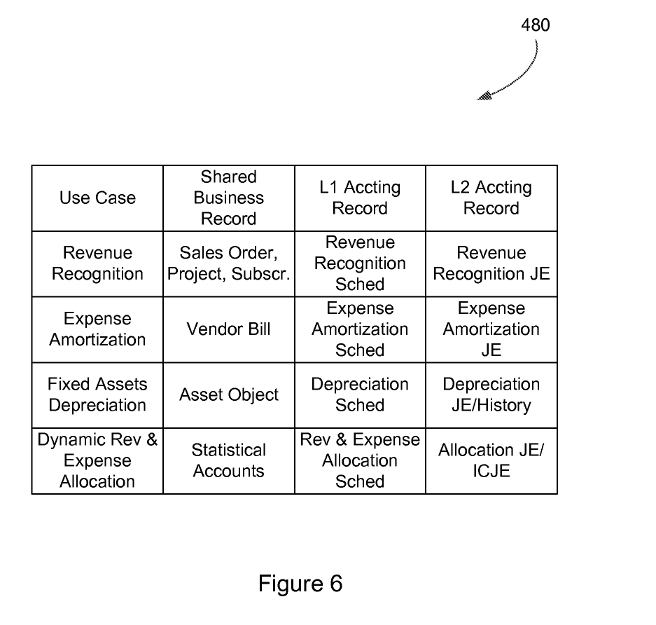

Table 480 in FIG. 6 provides several use cases illustrating examples of how a shared business record may be processed differently for two different accounting records L1 and L2. In a revenue recognition use case, a sales order, project or subscription is processed in accordance with a revenue recognition schedule for the L1 accounting record while it is processed as a revenue recognition journal entry (JE) for the L2 accounting record. In an expense amortization use case, a vendor bill is processed in accordance with an expense amortization schedule for the L1 accounting record while it is processed as an expense amortization journal entry (JE) for the L2 accounting record. In a fixed assets depreciation use case, an asset object is processed in accordance with a depreciation schedule for the L1 accounting record while it is processed as a depreciation journal entry (JE) or history for the L2 accounting record. In a dynamic revenue and expense allocation use case, statistical accounts are processed in accordance with revenue and expense allocation schedule for the L1 accounting record while it is processed as an allocation journal entry (JE) or inter-company JE (ICJE) for the L2 accounting record.

Certain embodiments of the present invention permit financial results to be adjusted on a per-book basis. For example, manual journal entries (JEs), including intercompany journal entries, may still be posted for individual accounting books. However, unlike traditional ERP/accounting software that requires a fully manual work process to make such an adjustment, embodiments of the invention provide users with toolkits, which can be used to automate these manual adjustments, if a given manual adjustment is frequently repeated with certain logical pattern. Scripts in these toolkits may be bundled and re-deployed across different records and even instances (e.g., sandbox account vs. standard production account) to avoid duplicated scripting effort.

Certain embodiments of the present invention also ensure data integrity across multiple accounting books by providing automatic data synchronization for parallel transactions in different accounting books. As illustrated in FIG. 3, one embodiment of a multi-book accounting system achieves this with split transaction line technology, which intelligently divides a standard transaction record and its line item details into a book generic attribute set 360 and book specific attributes 370. Book generic attributes 360 are maintained in transaction line detail table, which ensures the data integrity across multiple accounting book general ledgers by sharing the same value and enforcing cross-book update synchronization/restriction. On the other hand, book specific attributes are located in an extended transaction line book detail table with user defined cross-validation rules through general ledger segments. These cross-validation rules ensure the validity of book specific attributes within the shared book generic transaction context. For example, a sales invoice carries exactly the same sales price and total sales amount across all applicable accounting books, but users can define cross-book Cost of Acquisition (COA) mapping rules, which are controlled by mapping dimensions such as subsidiary, class, department or location, so that the same sales revenue amount is synchronized across multiple accounting books while posting to different revenue accounts on a per-book basis.

In certain embodiments, user interfaces may be provided for the parallel accounting books. In one approach, a NLReporting User concept is utilized to dynamically retrieve book specific accounting results through Analytics tools, such as reports, saved search, or KPIs. The NLReporting user approach enables a reporting engine to intelligently set the reporting data context based on the book selected by the user interface. This approach permits many existing reports and saved searches to continue to work in their pre-existing primary book context without any additional configuration, and can be enhanced to generate similar results in a secondary book context. It provides backward compatibility to existing users and their data analytical solution package, with a path of upgrade.

In some embodiments, implementation of the invention may utilize the following elements or components:

1) A unified data schema for business transaction and accounting impact In conventional ERP financial systems, the database table holding business attributes of a transaction (such as the sales invoice amount) is separated from the table holding the corresponding accounting impact (such as the currency and posting amount to each GL account from the sales invoice). As a result, it requires end users to manually trigger the generation of an accounting result, or do so through a scheduled task. In either case, the accounting result does not represent real-time data. The invention extends the existing transaction record “TransactionLineDetail” table into “TransactionLineDetail” and a joint table “TransactionLineBookDetails”. This mechanism enables users to immediately see the accounting result, once the business transaction is created and approved, because of the shared nature of these two logic database tables. By doing so, the real-time generation of an accounting result is available not only in the primary book (e.g., such as a GL), but also across all secondary books; 2) Unified data analytical tools

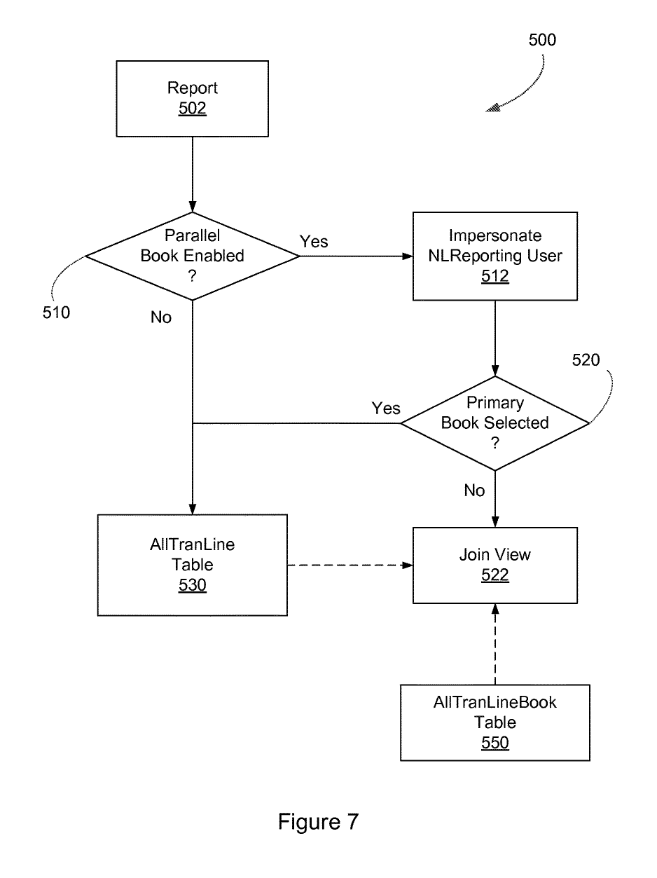

In conventional ERP systems, a user is required to use two separate reports to view the business attributes and corresponding accounting results, because the data is stored in separate tables. However, the invention allows users to create analytical reports/saved searches that access and provide both business attributes and accounting results at the same time. Such functionality empowers end users, especially corporate controllers and executives, by providing a holistic and real-time (and hence accurate) view of their business' financial performance. The inventive multi-book accounting extends this functionality across all accounting books, using the “NLReportingUser” concept described herein and represented in FIG. 7.

FIG. 7 is a flow chart or flow diagram illustrating an example of a process, method, operation, or function 500 for generating a report based on the inventive multi-book accounting method. As shown in the figure, logic that is part of the report generation process may be used to determine if parallel accounting books exist and if so, to “join” the relevant data if needed. In this example, an existing analytical report 502 is processed for a user interface by first determining, at step 510, whether a parallel book is enabled for the user interface. If a parallel book is not enabled, then report 502 is run against the all transactions line (AllTranLine) table 530. If a parallel book is enabled, then control branches to step 512, where report 502 is processed as though it was an NLReporting User. At step 520, it is determined whether a user of the user interface selected the primary book data for analysis, in which case the report is run against the AllTranLine table 530. If a book other than the primary book is selected, then report 502 is run against the AllTranLine Table 530 and the book specific AllTranLineBook Table 550 and the views joined at step 522.

Note that book specific transactions and the book specific attributes on a book generic transaction are generally controlled by the book permissions. If book permissions do not include access to a specific secondary book, nothing associated with that book is visible. Book record permissions may be separate from subsidiary permissions. For book generic transactions, posting to the general ledger occurs across all accounting books. It is generally determined by predefined accounting rules such as the accounts on item records, revenue recognition templates, and so on. If a user without access to a specific secondary book submits a book generic transaction, posting, then, for new transactions, default values from the system may be used to populate the secondary book, which is not made available to the user with access to the secondary book and, for transaction edits, previous values for the secondary book are preserved.

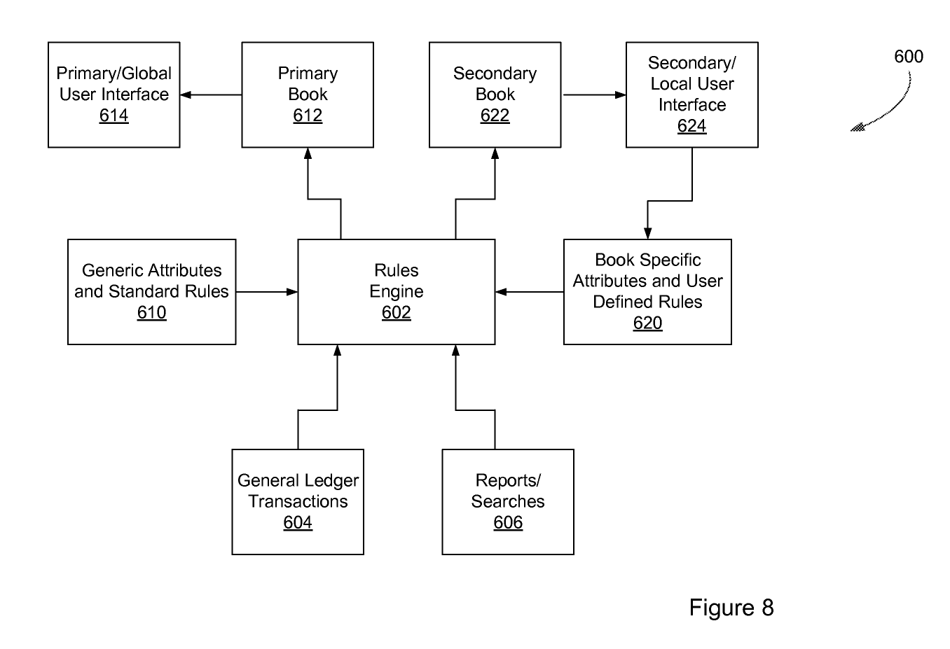

FIG. 8 is a functional block diagram illustrating an example of an architecture 600 for a multi-book accounting system. Architecture 600 features a rules engine 602 that applies accounting rules to general ledger transactions 604. Rules engine 602 applies stored generic attributes and standard accounting rules 610 to the general ledger transactions 604 in order to generate primary book 612, which is accessed using primary/global user interface 614. Rules engine 602 applies stored book specific attributes and user defined rules 620 to the general ledger transactions 604 in order to generate secondary book 614, which is accessed using secondary/local user interface 624. Stored reports or searches 606 may also be applied to the general ledger transactions 604 or primary book 612 in order to generate reports or search results.

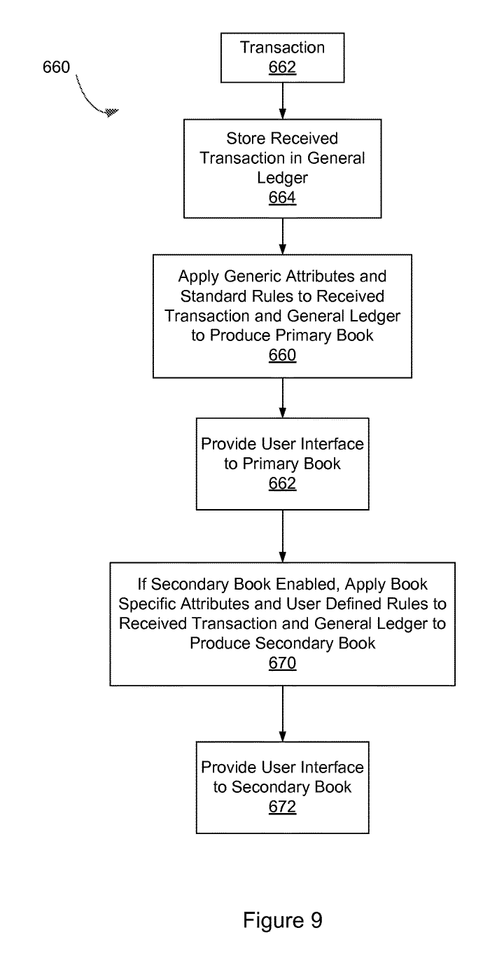

FIG. 9 is a control flow diagram that illustrates an example of a process 660 for processing a general ledger transaction 662 in real-time. In this example, transaction 662 is received and stored in a general ledger at step 664. At step 660, the rules engine 602 of FIG. 8 applies generic attributes and standard rules to the received transaction 662 and the general ledger in order to generate the primary book. At step 662, a user interface provides real-time data from the primary book that reflects the transaction 662. At step 670, if a secondary book is enabled, rules engine 602 applies book specific attributes and user defined rules to the transaction 662 and the general ledger to generate the secondary book. At step 672, a user interface provides real-time data from the secondary book that reflects the transaction 662. Thus, primary and secondary books are provided having different rules and attributes and user interfaces permit controllers to see the differential impact of a transaction upon the primary and secondary books in real-time.

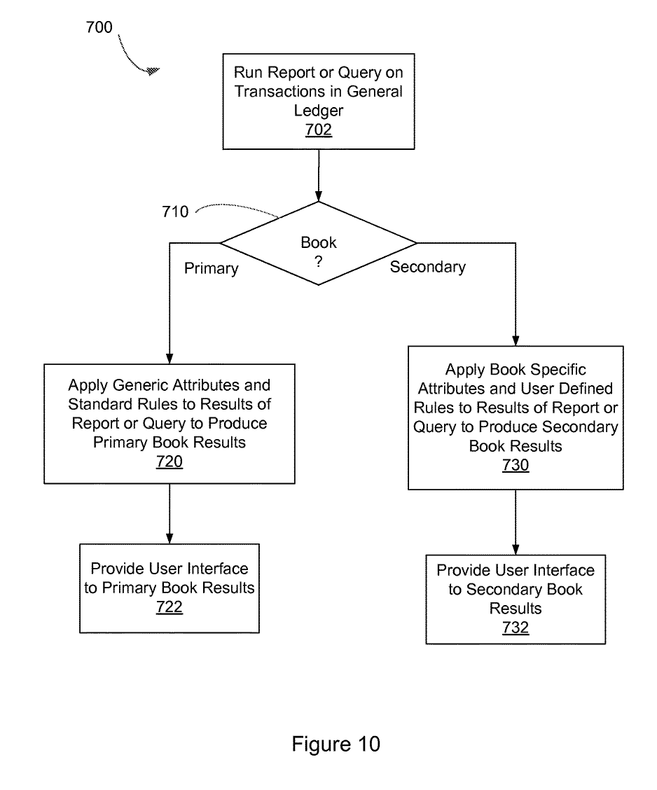

FIG. 10 is a control flow diagram that illustrates an example of a process 700 for running reports or search queries against transactions in a general ledger. When the report or query 702 is run, the book for which the report or query is run is determined at step 710. If the report or query pertains to the primary book, then control flow branches to step 720 where rules engine 602 applies the stored generic attributes and standard rules to the report or query data in order to product primary book results in that reflect the generic attributes and standard rules and the primary book results are provided to a user interface at step 722. If the report or query pertains to the secondary book, then control flow branches to step 730 where rules engine 602 applies the stored book specific attributes and user defined rules to the report or query results in order to product secondary book results that reflect the book specific attributes and rules and the secondary book results are provided to a user interface at step 732.

In this example, one set of general ledger data may be maintained and the primary and secondary book data is generated by using rules engine 602 to apply the corresponding rules to generate the primary and secondary books. This approach may permit many reports or search queries developed for a single book system to be run in the multi-book system. In another example, the different attribute and rule sets are applied to each transaction as it is received and the resulting book results stored as separate primary and secondary books.

For example, chart of accounts mapping may be provided that allows different account values to be used for transactions in secondary accounting books from those used in the primary book, thus creating different account balances and usage for the secondary book. Unless chart of accounts mapping is configured, all accounting books use the same accounts for transactions. Chart of Accounts Mapping allows a user to configure secondary accounting books to post to accounts that are different from those the primary book uses for posting. Unless differences are specifically mapped, secondary accounting books use the same account values for transactions as the primary book. Chart of accounts mapping provides the rules to determine which accounts to use for different accounting books. To select which mapping rule to use, the system first identifies the source of the account for the transaction. If the account is derived from the item records, the system uses item account mapping rules. If the user determines the account on the transaction record itself, the system uses global account mapping. Note that Chart of Accounts Mapping is an example of one way in which accounts may be different than those used in the primary book. If a transaction line has a revenue (or amortization) schedule in the primary book, but not in the secondary book, then the primary book might use a deferred revenue account (or deferred expense account) and the secondary book would use a revenue account (or expense account). Chart of Accounts mapping allows a user to define book specific posting account values; however, the inventive system can implement book specific posting of account data through other multi-book accounting mechanisms, such as a book specific revenue recognition schedule.

In one example, both global account mapping and item account mapping rely on dimensions. Each rule has a unique set of mapping dimension values. If a value is not set for a dimension, the mapping rule may be applied by the rules engine to all values for that dimension. Examples of dimensions for account mapping may include effective date, subsidiary, class, department, location or a custom mapping dimension. Custom mapping dimensions allow you to use a field on an item or transaction record as an additional dimension to more narrowly define the account mapping.

As noted above, revenue recognition and expense amortization often require different rules for different countries and industries. With the present multi-book accounting system, revenue recognition and expense amortization features may be book specific. Revenue allocation in multi-book accounting may allow specific revenue allocation for secondary books. Revenue commitments, revenue recognition schedules, expense amortization schedules, reports, KPIs and saved search may be provided on a per-book basis.

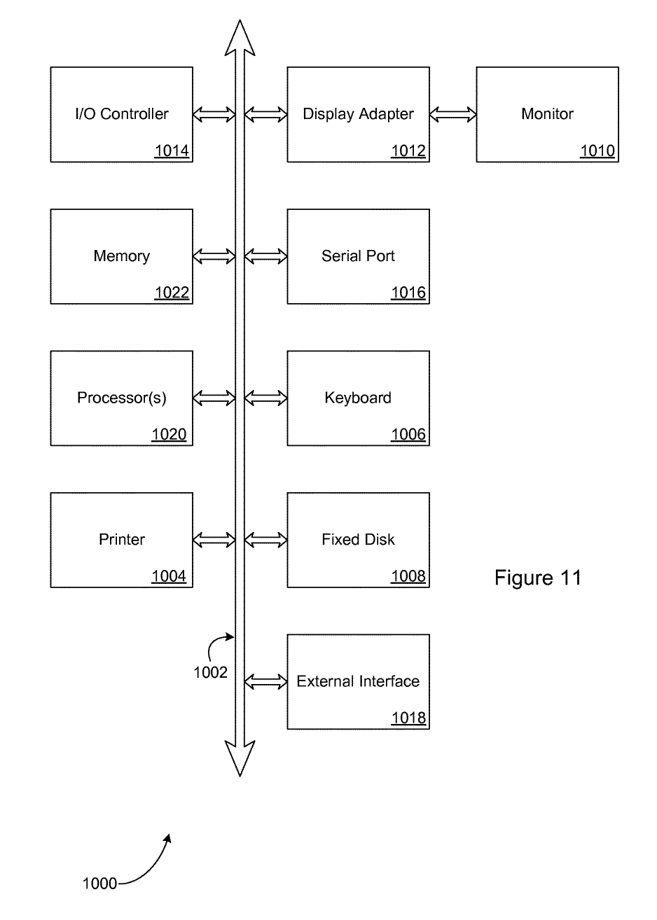

In accordance with one embodiment of the invention, the system, apparatus, methods, processes, functions, and/or operations for enabling multi-book accounting with real-time data may be wholly or partially implemented in the form of a set of instructions executed by one or more programmed computer processors such as a central processing unit (CPU) or microprocessor. Such processors may be incorporated in an apparatus, server, processing platform, client or other computing device operated by, or in communication with, other components of the system. As an example, FIG. 11 is a diagram illustrating elements or components that may be present in a computer device or system 1000 configured to implement a method, process, function, or operation in accordance with an embodiment of the invention. The subsystems shown in FIG. 10 are interconnected via a system bus 1002. Additional subsystems include a printer 1004, a keyboard 1006, a fixed disk 1008, and a monitor 1010, which is coupled to a display adapter 1012. Peripherals and input/output (I/O) devices, which couple to an I/O controller 1014, can be connected to the computer system by any number of means known in the art, such as a serial port 1016. For example, the serial port 1016 or an external interface 1018 can be utilized to connect the computer device 1000 to further devices and/or systems not shown in FIG. 11 including a wide area network such as the Internet, a mouse input device, and/or a scanner. The interconnection via the system bus 1002 allows one or more processors 1020 to communicate with each subsystem and to control the execution of instructions that may be stored in a system memory 1022 and/or the fixed disk 1008, as well as the exchange of information between subsystems. The system memory 1022 and/or the fixed disk 1008 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. An automatic real-time multi-book accounting system comprising:
at least one storage device having a first accounting book and a second accounting book stored therein;
at least one server device coupled to the storage device, the server device being configured to receive real-time transactions through a network and process each real-time transaction by:
splitting the real-time transactions into book generic attributes and book specific attributes;
applying a first set of accounting rules corresponding to the first accounting book to the book generic attributes and storing the result in the first accounting book, and
applying a second set of accounting rules corresponding to the second accounting book to the book specific attributes and storing the result in the second accounting book, where the second set of accounting rules differs from the first set of accounting rules; and
a user interface configured to provide real-time access to at least one of the first and second accounting books.

2. The automatic real-time multi-book accounting system of claim 1, wherein the second set of accounting rules includes a definition of one or more of the book specific attributes and the server device is further configured to apply the second set of accounting rules to the real-time transaction if the real-time transaction relates to one of the book specific attributes.

3. The automatic real-time multi-book accounting system of claim 2, wherein the user interface is further configured to permit a user to define the book specific attributes and the second set of accounting rules.

4-10. (canceled)

11. An automatic real-time multi-book accounting method, the method comprising:
storing a first accounting book and a second accounting book;
receiving real-time transactions and process each real-time transaction by:
splitting the real-time transactions into book generic attributes and book specific attributes;
applying a first set of accounting rules corresponding to the first accounting book to the book generic attributes and storing the result in the first accounting book, and
applying a second set of accounting rules corresponding to a second accounting book to the book specific attributes and storing the result in the second accounting book, where the second set of accounting rules differs from the first set of accounting rules; and
providing real-time user access to at least one of the first and second accounting books.

12. The automatic real-time multi-book accounting method of claim 11, wherein the second set of accounting rules includes a definition of one or more of the book specific attributes and the step of applying a second set of accounting rules corresponding to a second accounting book to the real-time transaction and storing the result in the second accounting book further comprises applying the second set of accounting rules to the real-time transaction if the real-time transaction relates to one of the book specific attributes.

13. The automatic real-time multi-book accounting method of claim 12, the method further comprising permitting a user to define the book specific attributes and the second set of accounting rules.

14-21. (canceled)
